(19) United States
(12) Patent Application Publication
(10) Pub. No.: US 2005/0211744 A1
(43) Pub. Date: Sep. 29, 2005

(54) Device for temporarily securing attachment auxiliary elements on a hand-held setting tool

(76) Inventor: Mariana Maglione, Gams (CH)

Correspondence Address: DAVID TOREN, ESQ.;ABELMAN FRAYNE & SCHWAB, 666 THIRD AVENUE, NEW YORK, NY, 10017-5621, US

(21) Appl. No.: 11/077,806

(22) Filed: Mar. 10, 2005

(30) Foreign Application Priority Data
Mar. 10, 2004 (DE) 10 2004 011 619.9

(51) Int. Cl. B25C 1/14

(52) U.S. Cl. 227/10

(57) ABSTRACT

A device for temporarily securing attachment auxiliary elements on a hand-held setting tool includes a base member (21) mountable in a region of the mouth (18) on the barrel (18) of the setting tool and having a passage (26) which extends substantially coaxially with the barrel (15) in a mounted condition of the base member (21) on the barrel (15), and at least one groove (22, 23, 24, 25, 34) for receiving and temporarily securing at least one section (41) of an attachment auxiliary element (40) and which extends substantially parallel to a longitudinal axis (36) of the passage (26) of the base member (21), and clamping jaws (28) which form flanks (27) of the at least one groove (22, 23, 24, 25, 34) and which are formed of at lest partially elastic material.

### BACKGROUND OF THE INVENTION

1. Field of the Invention

The present invention relates to a device for temporarily securing attachment auxiliary elements on a hand-held setting tool and including a base member mountable in a region of the mouth on the barrel of the setting tool and having a passage which extends substantially coaxially with the barrel in a mounted condition of the base member on the barrel, and at least one groove for receiving and temporarily securing at least one section of an attachment auxiliary element.

2. Description of the Prior Art

Devices for temporarily securing attachment auxiliary elements on hand-held tools are used for fixedly attaching, for a short time on a hand-held tool, attachment auxiliary elements such as fixing straps, pipe clamps, ceiling suspenders, cable bands, etc. With the setting tool, an attachment auxiliary element is attached to an object with an appropriate fastening element such as nail, bolt, pin, etc. The hand-held setting tools are usually driven with liquid, gaseous or solid fuels, or by pneumatic, electromechanical, or electropneumatic drives.

Australian Patent No. 486,273 discloses a setting tool with a device for temporarily securing attachment auxiliary elements such as, e.g., conduit clips and which is mounted in front of the setting tool on the tool barrel. The device has a receiving groove that extends transverse to the longitudinal axis of the setting tool barrel and in which means for securing an attachment auxiliary element is arranged.

The drawback of the known device consists in that attachment auxiliary elements, which have only a certain size can be secured with the device, and the holding force of the device is not sufficient for reliably securing large straps or pipe clamps.

Accordingly, an object of the present invention is to provide a device for temporarily securing of attachment auxiliary elements on a setting tool and in which the above-mentioned drawback is prevented.

### SUMMARY OF THE INVENTION

This and other objects of the present invention, which will become apparent hereinafter, are achieved by providing a device for temporarily securing attachment auxiliary elements on a setting tool of the type described above and in which the guide groove extends substantially parallel to a longitudinal axis of the passage of the base member, and the flanks of the at least one groove are formed by clamping jaws formed of at least partially elastic material.

The formation of clamping jaws of at least partially elastic material permits to clampingly hold an attachment auxiliary element in the guide groove, without using any auxiliary means. Because the guide groove extends parallel to the passage of the base member in which the setting tool barrel is received, a projecting section of the attachment auxiliary element can be clamped in the guide groove. Thereby a relatively large section, which projects from the holding section of the attachment auxiliary element, can be reliably held.

Advantageously, there are provided several guide grooves extending substantially parallel to the longitudinal axis of the passage of the base member. Thereby, a to-be-secured attachment auxiliary element can be secured on the device in different positions. This improves handling of a setting tool equipped with the inventive securing device.

Advantageously, at least two of several guide grooves have different groove widths. This permits to secure on the inventive device attachment auxiliary elements having different dimensions.

It is further advantageous when at least two of several grooves have different cross-sections. Thereby, attachment auxiliary elements having different outer profiles can be secured with the inventive device. Thus, it is advantageous when, e.g., one of the guide grooves has a substantially annular cross-section, whereby attachment auxiliary elements having round or cylindrical sections can be secured on the inventive device. It is further advantageous when at least one of the grooves has a substantially rectangular cross-section so that an attachment auxiliary element with an angular and, in particular, rectangular cross-section can be secured on the device.

Advantageously, the groove flanks taper from the groove bottom to the groove opening, whereby the groove width diminishes toward the groove opening. This permits to reliably secure attachment auxiliary elements having different dimensions in one and the same groove. Advantageously, the clamping jaws which form the groove flanks, are not rigid. Rather, the clamping jaws are formed so that they are elastically tiltable parallel to the longitudinal direction of the guide grooves. In this way, the guide grooves can be expanded for receiving an attachment auxiliary element having larger dimensions.

Advantageously, the groove depth diminishes from the mouth-side end of the base member to the opposite end. Thereby, they provide for good guidance of arcuate, bulged or inclined sections of the attachment auxiliary elements.

Advantageously, the base member is formed as an elastic plastic shaped part. This improves the clamping characteristics of the clamping jaws which form part of the base member, and increases the service life of the device.

It is further advantageous when magnets are provided in the region of the guide groove or grooves. The magnets provide for an additional holding force when the attachment auxiliary elements are formed of para-or-ferromagnetic materials.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS:

The drawings show:

FIG. 1 a side, partially cross-sectional view of a device according to the present invention, together with a setting tool;

FIG. 2 front view of the device shown in FIG. 1;

FIG. 3 a perspective view of another embodiment of a device according to the present invention; and

FIG. 4 a front view of the device shown in FIG. 3.

### DETAILED DESCRIPTION OF THE PREFERRED EMBODIMENTS

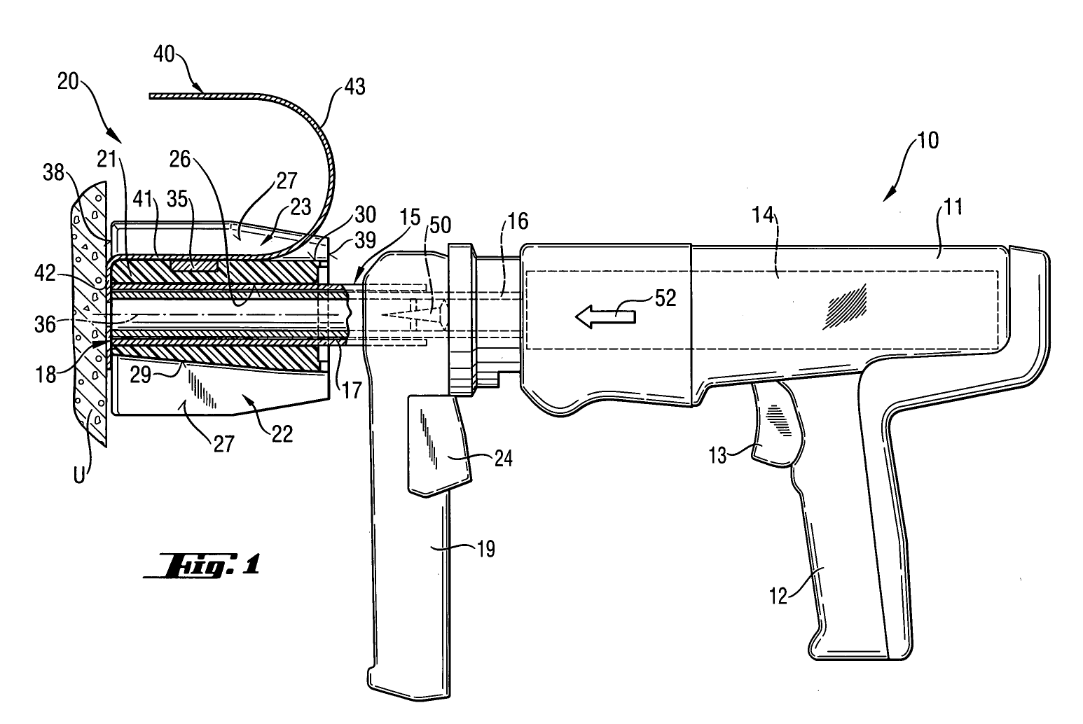

A hand-held setting tool 10, which is shown in FIG. 1, includes a device 20 for temporarily securing attachment auxiliary elements 40 and which is arranged in front of the tool 10 in the region of the tool mouth 18 and is supported on the barrel 15 of the setting tool 10. The setting tool 10 further includes a housing 11 with a handle 12 formed thereon. On the handle 12, there is provided an actuation switch 13 for initiating a setting process. The setting tool also includes a setting mechanism 14 which is not described here in detail but different embodiments of which are well known to those skilled in the art. The setting mechanism 14 can be driven, e.g., with solid or liquid fuels. In the setting direction 52, a bolt guide 16, which forms part of the barrel 15, adjoins the setting mechanism 14. Sidewise of the bolt guide 16, a magazine 19 for fastening elements 50 projects therefrom. The fastening elements 50 such as, e.g., nails, bolts, pins, and the like can be stored in the magazine 19 and are introduced therefrom in the bolt guide 16. The barrel 15 also includes a safety sleeve 17 that is displaceably supported on the bolt guide 16. The actuation of the setting tool 10 with the switch 13 is only then possible when the bolt guide 16 has been displaced by a certain amount in a direction opposite the setting direction 50 upon having been pressed against a constructional component U. If only the safety sleeve 17 is displaced in the direction opposite the setting direction 52, actuation of the setting tool 10 is not possible.

The device 20 for temporarily securing of attachment auxiliary elements 40 has a base member 21 that is essentially formed of an elastic plastic material. The base member 21 has a passage 26 into which the barrel 15 and the safety sleeve 17, if available, are inserted. The base member 21 is frictionally or forcelockingly held on the safety sleeve 17 and can be displaced together therewith over the bolt guide 16.

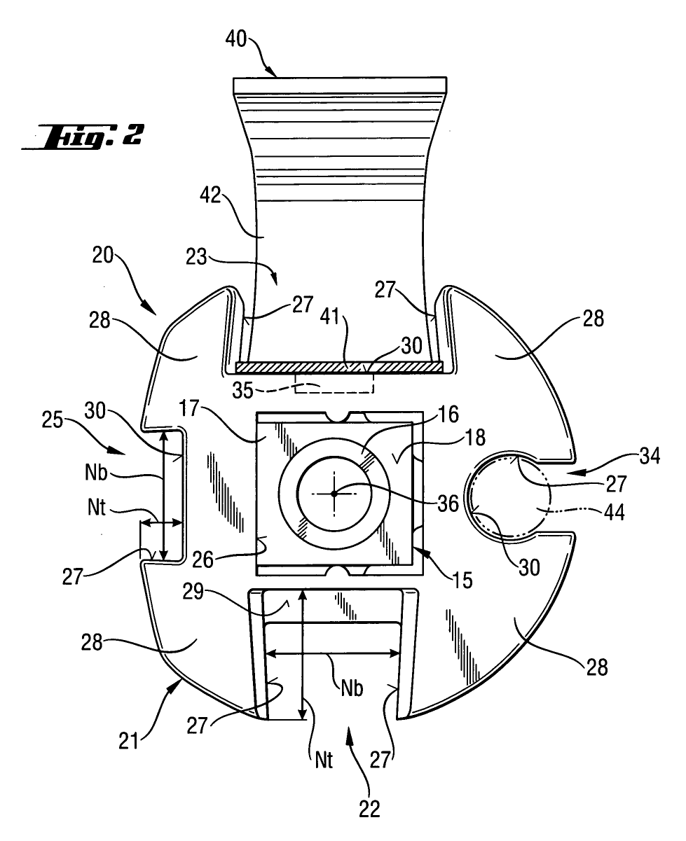

On each of the four sides of the base member 21 of the device 20, there is provided a guide groove 22, 23, 25, and 34 (see FIGS. 1-2), respectively. The guide grooves 22, 23, 25, and 34 extend coaxially with respect to the longitudinal axis 36 of the passage 26 in the base member 21. The groove flanks 27 or side walls of the guide grooves 22, 23, 25, 34 are formed by elongate clamping jaws 28 extending coaxially with the passage 26. Because of the elasticity of the material the base member 21 is formed of, the clamping jaws 28 can pivot within certain limits. The flanks 27 or the side walls of the guide grooves 22, 23, 25, 34 taper in the direction of the openings of the respective grooves 22, 23, 25, 34. As a result, the groove width Nb of the guide grooves 22, 23, 25, 34 is smaller in the regions of the respective groove openings than in the regions of the bottoms 29, 30 of the respective grooves 22, 23, 25, 34. The cross-sections of the respective grooves 22, 23, 25, 34 have different profiles and/or sizes and serve for clampingly receiving sections 41, 44 of the attachment auxiliary elements 40 which extend approximately parallel to the attachment axis of these attachment elements 40. The guide groove 34 has substantially an annular cross-section suitable for receiving, e.g., the annular cross-section 44 of an attachment auxiliary element 40. The three other guide grooves 22, 23, 25 have approximately from rectangular to trapezoidal cross-sections of different sizes for receiving, e.g., rectangular flat sections 41 of the attachment auxiliary elements 40.

The groove depth Nt of the guide groove 22 diminishes from the mouth-side end 38 to the opposite end 39 of the base member 21 so that the groove bottom 29 rises in a direction of the end 39. The groove depth Nt of the guide grooves 23, 24, 25 does not diminish so that their bottoms 30 extend substantially parallel to the passage 26 of the base member 21 of the device 20.

The attachment auxiliary element 40, which is shown in FIGS. 1-2, is formed as a securing clip and has a retaining section 42 which is securable on a constructional component U with a fastening element 50. A straight section 41 projects from the retaining section 42 at a right angle thereto. A hook-shaped section 43 adjoins the straight section 41. The hook-shaped section 43 can be used, e.g., for securing a bunch of conduits on the constructional component U.

In the bottom 30 of the guide groove 23, a magnet 35 is embedded which provides for retaining of the section 41 of the attachment auxiliary element 40, which is formed of steel, in the guide groove 43.

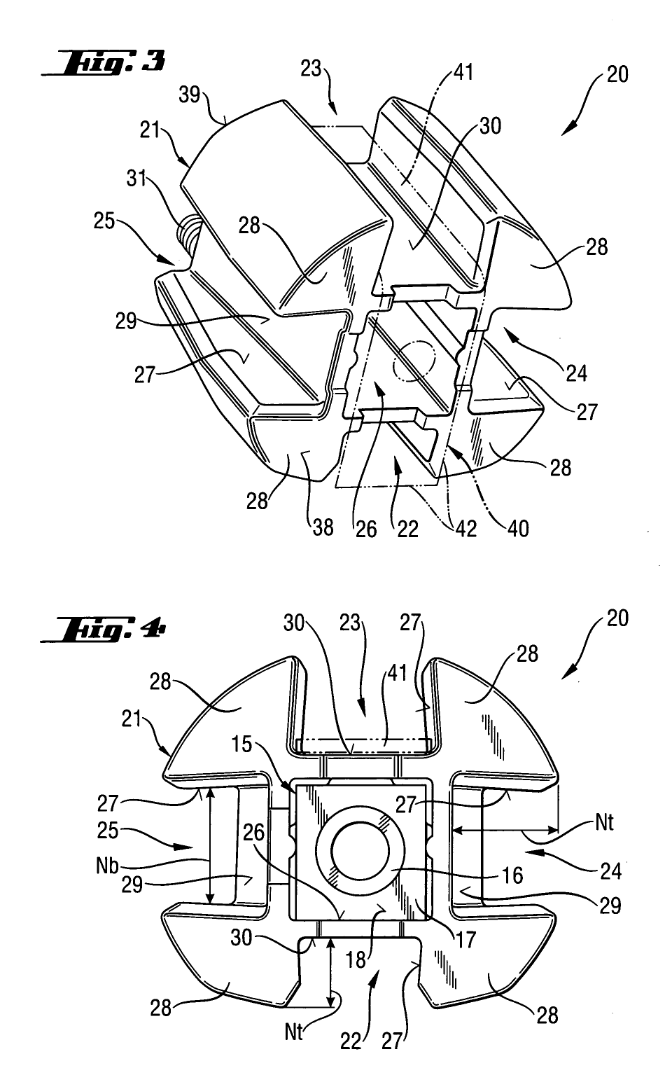

The embodiment of the device 20 for temporarily securing attachment auxiliary elements 40 on a setting tool, which is shown in FIGS. 3-4 differs from the device 20 shown in FIGS. 1-2 in that the length of the base member 21 is shorter, in the direction parallel to the passage 26, than the length of the base member 21 of the device 20 shown in FIGS. 1-2. The device 20 shown in FIGS. 3-4 further differs from that of FIGS. 1-2 in that all four of the guide grooves 22, 23, 24, 25 generally have approximately from rectangular to trapezoidal cross-section, and in that support means 31 is provided at the end 39 of the base member 21. The support means 31 provides for a resilient support of the device 20 against the housing 11 of the setting tool 10 or against the magazine 19 for fastening elements (shown in FIG. 1). The guide grooves 24 and 25 are approximately identical and both have their bottom 29 rising from the mouth-side end 38 to the opposite end 39. The guide grooves 22, 23 have a bottom 30 extending parallel to the passage 26 in the base member 21, so that the groove depth Nt of the grooves 22, 23 does not change or changes insignificantly. For description of other elements of the device 20 shown in FIGS. 3-4 and of other technical details, reference should be made to the description of FIGS. 1-2.

Though the present invention was shown and described with references to the preferred embodiments, such are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

1. A device for temporarily securing attachment auxiliary elements on a hand-held setting tool having a barrel (15) with a mouth (18), the device comprising a base member (21) mountable in a region of the mouth (18) on the barrel (15) of the setting tool and having a passage (26) which extends substantially coaxially with the barrel (15) in a mounted condition of the base member (21) on the barrel (15), and at least one groove (22, 23, 24, 25, 34) for receiving and temporarily securing at least one section (41) of an attachment auxiliary element (40) and which extends substantially parallel to a longitudinal axis (36) of the passage (26) of the base member (21); and clamping jaws (28) for forming flanks (27) of the at last one groove (22, 23, 24, 25, 34) and formed of at least partially elastic material.

2. A device according to claim 1, wherein the base member (21) has a plurality of guide grooves (22, 23, 24, 25, 34) extending substantially parallel to the longitudinal axis (36) of the passage (26) of the base member (21).

3. A device according to claim 2, wherein at least two of the plurality of grooves (22, 23, 24, 25, 34) have a different groove width (Nb).

4. A device according to claim 2, wherein at least two of the plurality of grooves (22, 23, 24, 25 34) have a different cross-section.

5. A device according to claim 2, wherein at least one of the plurality of grooves (22, 23, 24, 25 34) has a substantially annular cross-section.

6. A device according to claim 2, wherein at least one of the plurality of grooves (22, 23, 24, 25 34) has a substantially rectangular cross-section.

7. A device according to claim 1, wherein the groove flanks (27) of the at least one groove (22, 23, 24, 25) taper from a groove bottom (29, 30) toward a groove opening, whereby a groove width (Nb) diminishes toward the groove opening.

8. A device according to claim 1, wherein a groove depth (Nt) of the at least one groove (22, 24, 25) diminishes from a mouth-side end (38) of the base member (38) to an opposite end (39).

9. A device according to claim 1, wherein the clamping jaws (28) form part of the base member (21), and the base member (21) is formed as an elastic plastic shaped part.

10. A device according to claim 1, wherein a magnet (35) is arranged in a bottom (30) of the at lest one groove (23).
